(19) United States
(12) Patent Application Publication
(10) Pub. No.: US 2004/0057344 A1
(43) Pub. Date: Mar. 25, 2004

(54) Turntable stylus device

(75) Inventors: Nik Baumann, Leeds (GB); David Moore, Leeds (GB)

Correspondence Address: VENABLE, BAETJER, HOWARD AND CIVILETTI, LLP, P.O. BOX 34385, WASHINGTON, DC, 20043-9998, US

(73) Assignee: Nik Baumann, Leeds (GB)

(21) Appl. No.: 10/631,749

(22) Filed: Aug. 1, 2003

(30) Foreign Application Priority Data
Aug. 1, 2002 (GB) 0217856.4
Sep. 11, 2002 (GB) 0221001.1

(51) Int. Cl. G11B 20/00

(52) U.S. Cl. 369/18; 369/53.1

(57) ABSTRACT

A turntable stylus device 2 comprises recording medium motion detection means 8 operable to detect motion of the recording medium 10, and audio/visual output means operable to produce audio/visual effects in addition to, or instead of, those from the recording medium 10, said audio/visual effects being produced in response to an output of the recording medium motion detection means 8.

The present invention relates to turntables and particularly to modifications thereof.

Turntables (record players) are commonly used in places of entertainment, for example, pubs, bars and clubs by a DJ to provide a source of music. Normally, the DJ uses two turntables which are connected together by a mixer. The DJ places a record on each turntable and ‘mixes’ the two records together to produce the music. However, there is always a desire to make entertainment systems more sophisticated to improve the enjoyment for people who frequent bars and clubs.

According to a first aspect of the present invention there is provided a turntable adapted to rotate a recording medium having audio data recorded thereon, the turntable comprising recording medium motion detection means operable to detect motion of the recording medium, and audio/visual output means operable to produce audio/visual effects in addition to, or instead of, those from the recording medium, said audio/visual effects being produced in response to an output of the recording medium motion detection means.

The recording medium may be a phonograph/phonogram or vinyl record. The recording medium may comprise a CD or DVD. Preferably, the recording medium comprises at least a region thereof.

Preferably, in use, the recording medium motion detection means is adapted to be maintained above the recording medium. Preferably, the turntable comprises support means to maintain the recording medium motion detection means above the recording medium, preferably at a defined distance therefrom. Preferably, the distance is approximately 0.1 mm-5 mm, more preferably, approximately 0.5 mm-4 mm, and even more preferably, approximately 1 mm-3 mm above the recording medium. The turntable may comprise height adjustment means to vary and, preferably maintain the distance of the recording medium motion detection means above the recording medium.

Advantageously, maintaining the recording medium motion detection means above the recording medium when in use, allows the recording medium to be moved at almost any speed and/or direction without the risk of the recording medium motion detection means jumping, skipping or skating across with the recording medium. This would be the case if the recording medium motion detection means was in contact with the recording medium when in use.

Preferably, the support means comprises at least one arm on which the recording medium motion detection means may be fitted. The turntable may comprise first and second arms, the recording medium motion detection means being fitted to the first arm. The second arm may be fitted with a stylus cartridge. Alternatively, the recording medium motion detection means may be supported by an existing arm of the turntable. The recording medium motion detection means may replace the stylus cartridge on the arm.

Preferably, the recording medium motion detection means is adapted to measure direction, more preferably, speed (magnitude) and, more preferably, distance of movement of the recording medium as it rotates on the turntable. Preferably, the recording medium motion detection means is adapted to use optical navigation technology.

Preferably, the recording medium motion detection means comprises illumination means adapted to illuminate the recording medium, preferably a section of the recording medium substantially thereunder. Preferably, the illumination means illuminates the recording medium at an edge of a centre label of the recording medium. The recording medium motion detection means may illuminate the groove of the recording medium. The illumination means may comprise an LED.

Preferably, the recording medium motion detection means comprises light detection means adapted to detect light reflected away from the recording medium. Preferably, a pattern of light and dark is produced as an output. Preferably, the reflected light produces an output. Preferably, the light detection means comprises a lens which is preferably adapted to produce an image. Preferably, the image is substantially that of the illuminated region of the recording medium. Preferably, the image does not comprise code or pattern on the recording medium.

Preferably, the turntable comprises processing means adapted to process the output. The processing means may comprise a computer. Preferably, the processing means is adapted to form, measure and preferably record the image.

Preferably, the audio/visual output means comprises a computer. Preferably, the audio/visual output are stored on the audio/visual output means and are adapted to be triggered by the output from the recording medium motion detection means.

Examples of audio effects include .mp3, .wav, aiff etc which may be transmitted by means of an amplifier and speaker system. Examples of video effects include DVD, .avi, .divX etc which may be transmitted by means of a monitor or screen system.

Preferably, the turntable is adapted to rotate in either a clockwise or anti-clockwise direction. The recording medium may be rotated/moved on the turntable either by drive means or manually.

According to a second aspect of the present invention, there is provided a method of producing audio/visual effects, the method comprising:—

(i) moving a recording medium on a turntable;

(ii) detecting motion of the recording medium by recording medium motion detection means; and

(iii) processing output from the record motion detection means to produce audio/visual effects in addition to, or instead of, those from the recording medium.

Preferably, said moving comprises rotating the recording medium.

Preferably, the method comprises illuminating the recording medium, preferably a region of the recording medium underneath the recording medium motion detection means. Preferably, the illuminated region does not comprise code or any pattern. Advantageously, and preferably, illuminating the recording medium reveals a microscopic pattern of highlights and shadows in the recording medium, preferably at an edge of a centre label of the recording medium. The recording medium motion detection means may illuminate the groove of the recording medium.

Preferably, the method comprises detecting light reflected off the recording medium. Preferably, the pattern is reflected off the surface of the recording medium and upwards into light detection means. The light detection means may comprise a lens. Preferably, the reflected light forms an image in the light detection means.

Preferably, the method comprises forming, measuring and recording the image. Preferably, the processing comprises tracking motion of sequential images to produce an output. Preferably, the processing comprises identifying substantially common features between sequential images and, preferably determining the distance between them. Preferably, the processing comprises converting the distance between sequential images into X and Y coordinates to indicate movement of the recording medium as it rotates.

Advantageously, use of the turntable and apparatus as defined by the first and second aspects, respectively, does not rely on detecting and reading any form of code or pattern present on the recording medium as in prior art apparatuses. In contrast, the apparatus of the present invention essentially records images of a region of the recording medium directly underneath the detection means, at whatever position the detection means is above the recording medium, for example, above the centre label or above the groove of the record. Accordingly, advantageously, there is no need to accurately align the detection means with any particular part of the recording medium as with the prior art which improves usability.

All of the features described herein may be combined with any of the above aspects, in any combination.

For a better understanding of the invention, and to show how embodiments of the same may be carried into effect, reference will be made, by way of example, to the accompanying diagrammatic drawings, in which:—

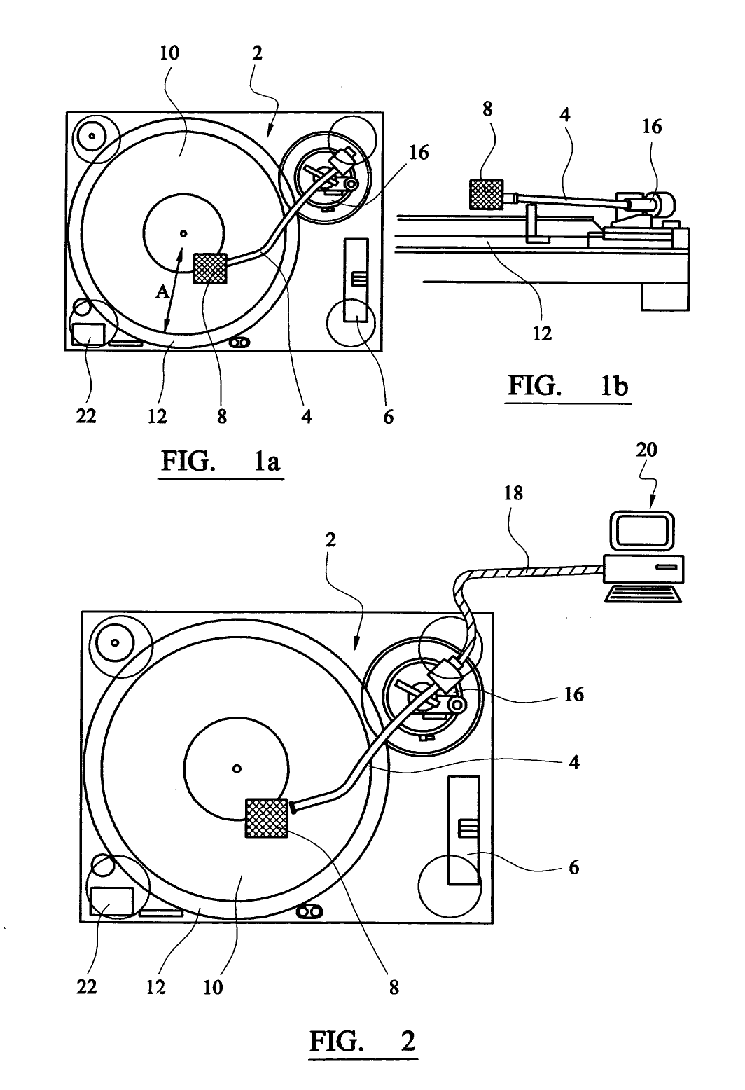

FIG. 1a shows a schematic plan view of a first embodiment of a turntable;

FIG. 1b shows a schematic side view of the turntable shown in FIG. 1a;

FIG. 2 shows a schematic enlarged view of the turntable as shown in FIG. 1a in use;

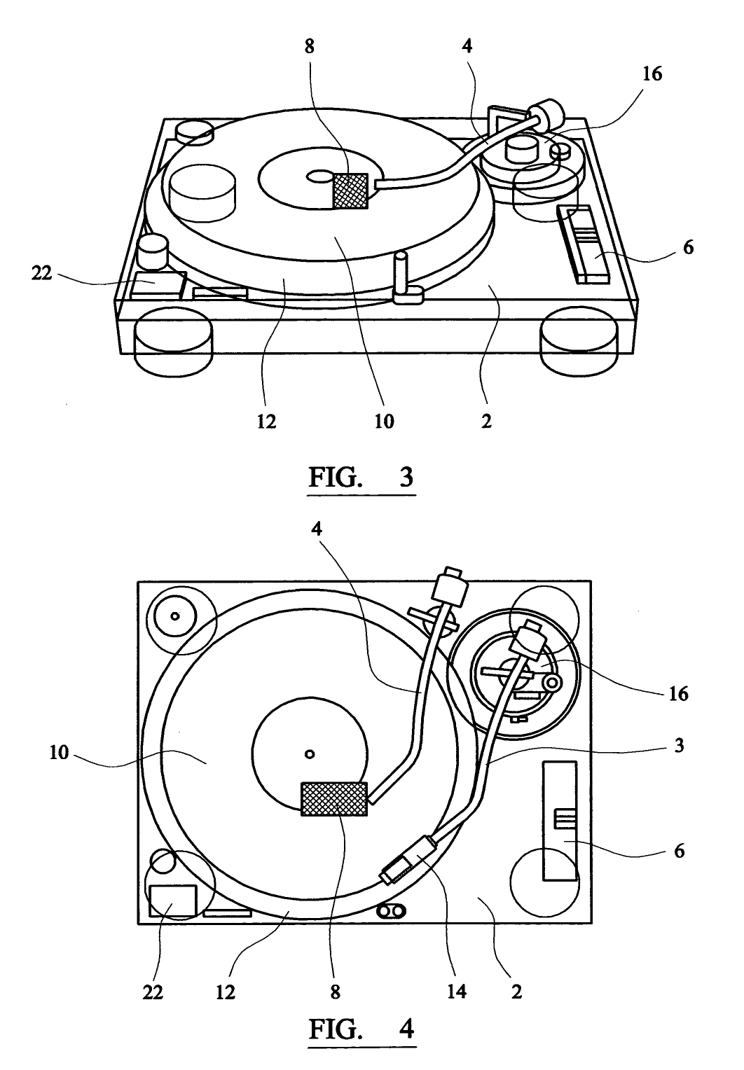

FIG. 3 shows a schematic perspective view of the turntable;

FIG. 4 shows a schematic plan view of a second embodiment of the turntable; and

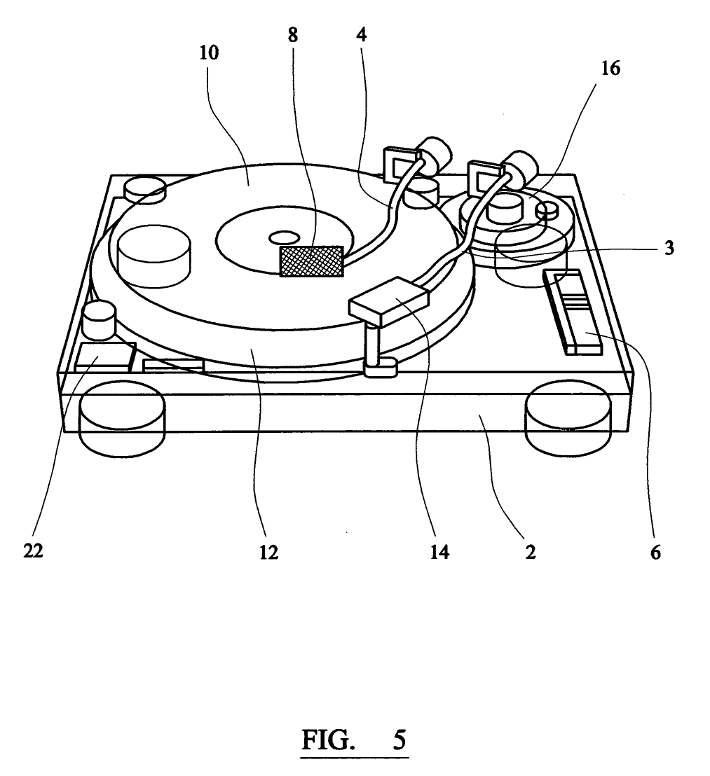

FIG. 5 shows a schematic perspective view of the turntable shown in FIG. 4.

Referring to FIGS. 1-3, there is shown a record player also known as a turntable 2 consisting a circular platter 12 on which a vinyl record 10 is placed, and a pitch control 6 which is used to vary the speed of rotation of the platter 12 and, hence record 10 thereon. Rotation of the turntable 2 is started and stopped by an on/off switch 22.

In normal use, the platter 12 and, hence, record 10 rotates in a clockwise direction. However, a disk jockey (DJ) operating the turntable 2 is able to manually cause the platter 12 and, hence, record 10 to rotate in an anti-clockwise direction. The turntable 2 further consists of a single tone arm 4 which can be positioned at different places across the record 10 on the platter 12 as indicated by arrow ‘A’.

In a first embodiment of the turntable 2 shown in FIGS. 1-3, one end of the tone arm 4 is fitted with an optical cartridge in which an optical navigation sensor 8 is fitted. A suitable sensor 8 may be obtained from Agilent Technologies, Inc. (395 Page Mill Rd., P.O. Box #10395 Palo Alto, Calif. 94303, USA) and is able to detect the direction, speed and distance of movement of the record 10 as it rotates on the platter 12 of the turntable 2 in either a clockwise or anti-clockwise direction.

As shown in FIG. 1b, the tone arm 4 is arranged so that the optical sensor 8 is raised above the record 10. Hence, there is no contact between the record 10 and the sensor 8. The sensor 8 has to be at a certain height above the record 10 so that sensing is possible, and a height adjustment device 16 is provided to vary the height as desired. The turntable is then switched on so that the record 10 rotates. The sensor 8 monitors and measures sequential surface images in the groove on the record 10, and mathematically determines the direction and magnitude of movement of the record 10 as it rotates. Because the optical sensor 8 does not contact the groove on the record 10, the sensor 8 stays in the same position unless it is moved to a new position. This may be achieved either manually by the DJ or by a separate drive unit (not shown).

The optical sensor 8 functions as follows. The sensor 8 includes an LED (not shown) which illuminates an area of the record 10 immediately thereunder thereby revealing a microscopic pattern of highlights and shadows in the groove of the record 10. This pattern is reflected off the surface of the record 10 and upwards into a lens (not shown) which collects the reflected light pattern and forms an image in the sensor 8. The sensor measures and records images of the light pattern at a rate of 1500 images per second or more, fast enough so that sequential pictures of the record 10 overlap. The images recorded by the sensor 8 are then processed. Processing of the sequence of light patterns identifies texture or other features in the pictures and also tracks their motion. Much of the same visual material can be recognized in sequential frames. The sensor 8 identifies common features between these sequential frames and determines the distance between them. This information is then translated into X and Y coordinates to indicate movement of the record 10 as it rotates.

Once the optical sensor 8 has determined the direction and magnitude of movement of the record 10, an output is produced which is transmitted along cable 18 to a computer 20. The computer 20 is programmed with software which is able to control a variety of different multimedia effects, for example, audio or video playback. The output from the sensor 8 triggers the computer to play either sound or song files (.mp3, .wav, aiff etc) or video files (DVD, .avi, .divX etc) as if they were physically pressed onto the record 10. Audio output can be transmitted by an amplifier and speaker system, and video output can be transmitted on a monitor or screen system.

In a second embodiment of the turntable 2 shown in FIGS. 4 and 5, the turntable 2 is fitted with two tone arms 2,3. A first tone arm 4 is fitted with the optical navigation sensor 8 as in the first embodiment shown in FIGS. 1-3, and a second tone arm 3 is fitted with a traditional stylus cartridge 14.

In use, the operator (DJ) starts the turntable 2 so that the record 10 rotates. He then positions the second tone arm 3 so that the stylus 14 contacts the groove on the record 10 so that the music can be heard by an amplifier and speaker system (not shown). He then moves the first tone arm 4 across the platter 12 so that it is maintained in a positioned raised above the record 10 such that the optical sensor can determine the direction and magnitude of rotation.

As the operator increases or decreases the speed or pitch of rotation of the record 10 via either the pitch control 6 or by hand, the stylus cartridge 14 on the second tone arm 3 will pick up different sounds in accordance with the change in speed of the record 10. At the same time, this change in rotation speed or the record 10 will be sensed by the optical sensor 8 thereby resulting in a change of output from the computer 20 be it either audio or visual, depending on the software and set-up of the computer 20.

Advantages of the turntable 2 reside in the sophisticated manner in which the rotation of the record 10 can be harnessed to produce a variety of multimedia effects. The turntable 2 can be adapted so that the existing tone arm 4 is fitted with the optical sensor 8 by replacing the normal stylus cartridge 14. Alternatively, a tone arm 4 having the sensor 8 fitted thereto can be attached to the turntable 2 as well as the normal tone arm 3.

A device which detects the direction and distance of movement of a vinyl record, on a record player. It can do this by making use of optical navigation technology, this measures changes in position by optically acquiring sequential surface images and mathematically determining the direction and magnitude of movement.

A device that uses the detected movement information to control the playback and manipulation of multimedia from a computer. (Example) Multimedia would be audio and graphics with their editable parameters.

A device (A) to sense the movement of a record on a record player, in order to control the playback of media (audio video etc.) on a secondary system (e.g. a computer). The movement sensor (A) is of a particular type and requires no other parts or coded patterns to be read by the sensor.

Part (A) is an attachable second tone arm that houses the optical navigation sensor. This would just attach to an existing turntable with no other modifications. The speed and direction of the vinyl record can then be calculated and used for the playback and manipulation of audio and visual media.

Part (A) can also be a new cartridge that can attach to the original existing tone arm on a standard record player. By taking off the standard cartridge with the needle and replace this with the optical navigation sensor. The speed and direction of the vinyl record can then be calculated and used for the playback and manipulation of audio and visual media.

The optical sensor is in use already in optical mice. I am only patenting a specific and novel use for this technology. The technology works by using a plastic lens that collects the reflected light and forms an image on a sensor. If you were to look at the image, it would be a black-and-white picture of a tiny section of the surface. The sensor continuously takes pictures as the mouse moves. The sensor takes pictures quickly-1500 pictures (frames) per second or more-fast enough so that sequential pictures overlap. The images are then sent to the optical navigation engine for processing. Optical mice illuminate an area of the work surface with an LED, to reveal a microscopic pattern of highlights and shadows. These patterns are reflected onto the navigation sensor, which takes pictures at a rate of 1500 images per second or more.

The optical navigation engine is the brain of the mouse. It identifies texture or other features in the pictures and tracks their motion. Much of the same visual material can be recognized in sequential frames. Through a patented image-processing algorithm, the optical navigation engine identifies common features between these sequential frames and determines the distance between them. This information is then translated into X and Y coordinates to indicate mouse movement.

The Navigation Engine identifies common features in sequential images to determine the direction and amount of mouse movement.

We would use this sensor above a vinyl record to record the movement of the vinyl and relay these coordinates to the computer. The computer could then play back an audio or media file using this information. So if I played the record forwards the audio from the computer would play forwards and if I stopped the record or moved it backwards then the computer would respond and stop the audio or play it backwards. The information regarding the optical sensor technology was acquired from

www.agilent.com/semiconductors

For product information and a complete list of distributors, please go to our web site.

www.agilent.com/semiconductors

For technical assistance call:

Americas/Canada: +1 (800) 235-0312 or (408) 654-8675

Europe: +49 (0) 6441 92460

Data subject to change.

Copyright © 2001 Agilent Technologies, Inc.

Nov. 5, 2001

5988-4554EN

The first aim of our invention is an attachable second arm that clips onto the turntable and places the optical navigation sensor (part A) over the record without the need to take off the original needle and cartridge. This allows greater flexibility for the user, as they would not have to make any changes to their existing turntable set up. But instead they would just add to it with the clip on second tone arm.

The second aim of our invention is to do away with the original cartridge and replace it with an optical sensor part (A) that clips on in the form of a new cartridge.

The invention can be used with most existing record players and requires no modifications to the workings of the record player itself.

The invention consists of one part (A)

Part (A) record movement sensor housed inside an attachable cartridge or placed inside a second attachable tone arm.

FIG. 1 shows the positioning of movement sensor (A) housed inside an attachable cartridge on a record players tone arm. This position can be any radius from the inside of the turntable to the outer edge but would be best placed as shown in FIG. 1.

FIG. 2 shows a clear wire frame of the design (top view) and where the cartridge can be attached to the tone arm in its up position.

FIG. 3 Shows the cartridge (the size and shape of which may be amended) from a 3D perspective to give a better idea of the design.

FIG. 4 this shows a second tone arm that would house the sensor and would be fixed to the existing turntable in the position as shown in diagram 4.

FIG. 5 this shows a second tone arm that would house the sensor and would be fixed to the existing turntable in the position as shown in diagram 4 but from a 3D perspective.

An example of the invention's use is to control the audio or video playback on a computer. Using appropriately written software, the sound or song file (.mp3 .wav .aiff etc) or video file (DVD avi .divX etc) can be played as if it were on physically pressed onto the record.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A turntable adapted to rotate a recording medium having audio data recorded thereon, the turntable comprising recording medium motion detection means operable to detect motion of the recording medium, and audio/visual output means operable to produce audio/visual effects in addition to, or instead of, those from the recording medium, said audio/visual effects being produced in response to an output of the recording medium motion detection means.

2. A turntable as claimed in claim 1, wherein the recording medium is a phonograph/phonogram or vinyl record.

3. A turntable as claimed in claim 1, wherein the turntable comprises support means to maintain the recording medium motion detection means above the recording medium at a defined distance therefrom.

4. A turntable as claimed in claim 1, wherein the turntable comprises height adjustment means to vary and maintain the distance of the recording medium motion detection means above the recording medium.

5. A turntable as claimed in claim 3, wherein the support means comprises at least one arm on which the recording medium motion detection means is fitted.

6. A turntable as claimed in claim 1, wherein the recording medium motion detection means is adapted to measure distance of movement of the recording medium as it rotates on the turntable.

7. A turntable as claimed in claim 1, wherein the recording medium motion detection means comprises illumination means adapted to illuminate the recording medium.

8. A turntable as claimed in claim 7, wherein the illumination means illuminates the recording medium at an edge of a centre label of the recording medium.

9. A turntable as claimed in claim 7, wherein the recording medium motion detection means illuminates the groove of the recording medium.

10. A turntable as claimed in claim 1, wherein the recording medium motion detection means comprises light detection means adapted to detect light reflected away from the recording medium.

11. A turntable as claimed in claim 10, wherein the light detection means comprises a lens which is adapted to produce an image.

12. A turntable as claimed in claim 11, wherein the image is substantially that of the illuminated region of the record.

13. A turntable as claimed in claim 1, wherein the turntable comprises processing means adapted to process the output.

14. A turntable as claimed in claim 1, wherein the audio/visual output means comprises a computer.

15. A method of producing audio/visual effects, the method comprising:—
(i) moving a recording medium on a turntable;
(ii) detecting motion of the recording medium by recording medium motion detection means; and
(iii) processing output from the record motion detection means to produce audio/visual effects in addition to, or instead of, those from the recording medium.

16. A method as claimed in either claim 16, wherein the method comprises illuminating the recording medium.

17. A method as claimed in claim 15, wherein said method comprises illuminating a region of the recording medium underneath the recording medium motion detection means.

18. A method as claimed in claim 15, wherein the method comprises detecting light reflected off the recording medium.

19. A method as claimed in claim 18, wherein the reflected light forms an image in the light detection means.

20. A method as claimed in claim 19, wherein the method comprises forming, measuring and recording the image.
